(19) United States
(12) Patent Application Publication
(10) Pub. No.: US 2026/0165426 A1
(43) Pub. Date: Jun. 18, 2026

(54) SHOE UPPER WITH A LAYERED STRUCTURE FOR A SPORTS SHOE

(71) Applicant: adidas AG, Herzogenaurach (DE)

(72) Inventors: Quentin FERRARI, Herzogenaurach (DE); Raphael CURET, Nuremberg (DE); James SLACK, Nuremberg (DE); Andrew GORDON, Nuremberg (DE); Yanfen PENG, Fuzhou City (CN)

(21) Appl. No.: 19/416,262

(22) Filed: Dec. 11, 2025

(30) Foreign Application Priority Data
Dec. 12, 2024 (DE) 10 2024 137 464.0

(51) Int. Cl. A43B 23/02; A43B 5/02

(52) U.S. Cl. CPC A43B 23/0235; A43B 5/025; A43B 23/021; A43B 23/0215; A43B 23/026; A43B 23/028

(57) ABSTRACT

The present disclosure relates to a shoe upper, such as for a sports shoe, comprising a layered structure having a first layer, a second layer, and an intermediate foam layer between the first layer and the second layer, wherein the intermediate foam layer comprises a polyamide, PA, foam material. The present disclosure also relates to a sports shoe comprising such a shoe upper.

### CROSS REFERENCE TO RELATED APPLICATIONS

This application claims priority to German Patent Application No. 10 2024 137 464.0, filed Dec. 12, 2024, which is incorporated by reference herein in its entirety.

### TECHNICAL FIELD

The present disclosure relates to a shoe upper, such as for a sports shoe, comprising a layered structure having a first layer, a second layer, and an intermediate foam layer between the first layer and the second layer, wherein the intermediate foam layer comprises a polyamide (PA) foam material. The present disclosure also relates to a sports shoe comprising such a shoe upper.

### BACKGROUND

A shoe is commonly described as the combination of a shoe upper and a sole. Typically, the shoe upper covers regions such as the instep, the toe, the medial side, the lateral side, and the heel of a wearer's foot and provides an opening to allow the wearer to step inside the footwear. The shoe upper typically performs several different functions, such as protection, support and comfort. The sole is connected to the upper such that the sole's top side faces an underfoot portion of the upper, and its bottom side touches the ground during ordinary use of the shoe.

Foam materials have become a crucial component in the design and manufacturing of modern footwear, especially in the soles for athletic and sports shoes. The development and use of foam in shoes are rooted in the need for enhanced comfort, cushioning, support, and performance. Over time, the technology and materials used in foam production have advanced significantly. Manufacturers have developed various types of foam, each with unique properties tailored to specific performance needs. For example, memory foam offers a custom fit by molding to the shape of the foot, while polyurethane (PU) foam provides more durability and energy return.

Current foams still have some deficiencies when it comes to providing the above noted requirements to a shoe upper. One common disadvantage of the shoe uppers manufactured with foam is that some foam materials are perceived to be relatively stiff and not as flexible as desired for high quality football shoes.

Against this background, it is an object of the present disclosure to provide an improved shoe upper.

### BRIEF SUMMARY

The present disclosure is directed to a shoe having a layered structure. In some embodiments, the layered structure of the shoe can comprise a foam layer that provides flexibility that may be desired for athletic shoes.

A first embodiment (I) of the present disclosure is directed to a shoe upper comprising a layered structure comprising: a first layer, a second layer; and an intermediate foam layer between the first layer and the second layer, wherein the intermediate foam layer comprises a polyamide (“PA”) foam material.

In a second embodiment (II), in the shoe upper of the first embodiment (I), the first layer is adapted to be turned inward of the shoe upper, the second layer is adapted to be turned outward of the shoe upper, the intermediate foam layer is adapted to provide stretchability and cushioning for ball contacts, or a combination thereof.

In a third embodiment (III), in the shoe upper of any one of embodiments (I)-(II), the first layer forms an innermost surface of the shoe upper.

In a fourth embodiment (IV), in the shoe upper of any one of embodiments (I)-(III), the second layer forms an outermost surface of the shoe upper.

In a fifth embodiment (V), in the shoe upper of any one of embodiments (I)-(IV), the layered structure is arranged in a vamp region of the shoe upper.

In a sixth embodiment (VI), in the shoe upper of any one of embodiments (I)-(V), the layered structure is arranged in a forefoot region of the shoe upper.

In a seventh embodiment (VII), in the shoe upper of any one of embodiments (V)-(VI), the layered structure is arranged in a toe region of the shoe upper.

In an eighth embodiment (VIII), in the shoe upper of any one of embodiments (I)-(VII), the first layer is a first textile layer.

In a ninth embodiment (IX), in the shoe upper of any one of embodiments (I)-(VII), the first layer comprises a coating, a film, a synthetic leather, or a leather.

In a tenth embodiment (X), in the shoe upper of any one of embodiments (I)-(IX), the second layer is a second textile layer.

In an eleventh embodiment (XI), in the shoe upper of any one of embodiments (I)-(IX), the second layer comprises a coating, a film, a synthetic leather, or a leather.

In a twelfth embodiment (XII), in the shoe upper of any one of embodiments (I)-(XI), one or more of the first layer and the second layer comprises a fabric.

In a thirteenth embodiment (XIII), in the shoe upper of any one of embodiments (I)-(XII), one or more of the first layer and the second layer comprises a PA material, a polyurethane (“PU”) material, and/or a thermoplastic polyurethane (“TPU”) material.

In a fourteenth embodiment, (XIV), in the shoe upper of any one of embodiments (I)-(XIII), one or more of the first layer or the second layer comprises a thickness between 0.05 mm and 1.0 mm.

In a fifteenth embodiment (XV), in the shoe upper of any one of embodiments (I)-(XIV), the intermediate foam layer comprises a thickness between 0.5 mm and 1.5 mm.

In a sixteenth embodiment (XVI), in the shoe upper of any one of embodiments (I)-(XV), the material of the intermediate foam layer is manufactured by a supercritical foaming process.

In a seventeenth embodiment (XVII), the shoe upper of any one of embodiments (I)-(XVI) further comprises a foil layer on the second layer adapted to provide a coating for the shoe upper.

In an eighteenth embodiment (XVIII), in the shoe upper of embodiment (XVII), the foil layer comprises a TPU material.

In a nineteenth embodiment (XIX), in the shoe upper of any one of embodiments (XVII)-(XVIII), the foil layer comprises a thickness between 0.01 mm and 0.1 mm.

In a twentieth embodiment (XX), in the shoe upper of any one of embodiments (XVII)-(XIX), the foil layer is extruded.

In a twenty-first embodiment (XXI), in the shoe upper of any one of embodiments (XVII)-(XX), wherein the foil layer comprises a hardness between 40 and 90 Shore A.

In a twenty-second embodiment (XXII), the shoe upper of any one of embodiments (I)-(XXI) further comprises a resin layer as an outermost layer having a PU material.

In a twenty-third embodiment (XXIII), in the shoe upper of embodiment (XXII), the resin layer comprises a thickness between 0.01 mm and 0.1 mm.

In a twenty-fourth embodiment (XXIV), in the shoe upper of any one of embodiments (I)-(XXIII), one or more of the layers are joined by an adhesive film.

In a twenty-fifth embodiment (XXV), in the shoe upper of any one of embodiments (I)-(XXIV), the layered structure is arranged in a midfoot region and/or a tongue region of the shoe upper.

In a twenty-sixth embodiment (XXVI), in the shoe upper of any one of embodiments (I)-(XXV), the layered structure further comprises a profile element.

In a twenty-seventh embodiment (XXVII), the shoe upper of any one of embodiments (I)-(XXVI) further comprises multiple apertures in the intermediate foam layer.

In a twenty-eighth embodiment (XXVIII), in the shoe upper of embodiment (XXVII), the multiple apertures are located in the first layer and/or the second layer.

In a twenty-ninth embodiment (XXIX), in the shoe upper of any one of embodiments (I)-(XXVIII), the first layer, the second layer and the intermediate layer form a single piece structure extending from a top surface of the shoe upper to a bottom surface of the shoe upper.

In a thirtieth embodiment (XXX), in the shoe upper of the twenty-ninth embodiment (XXIX), the single piece structure completely encircles a foot of a wearer when in use.

In a thirty-first embodiment (XXXI), in the shoe upper of any one of embodiments (XXIX)-(XXX), the single piece structure is arranged in a forefoot region of the shoe upper.

A thirty-second embodiment (XXXII) of the present disclosure is directed to a sports shoe comprising a shoe upper of any one of embodiments (I)-(XXX).

In a thirty-third embodiment (XXXIII), the sports shoe of embodiment (XXXII) is a soccer shoe.

In a thirty-fourth embodiment (XXXIV), in the sports shoe of embodiment (XXXIII), the soccer shoe is laceless.

In a thirty-fifth embodiment (XXXV), in the sports shoe of any one of embodiments (XXXII)-(XXXIV), the intermediate foam layer is arranged only in a throat region of the shoe upper.

### BRIEF DESCRIPTION OF THE FIGURES

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the present disclosure is generally described in the context of these embodiments, it should be understood that it is not intended to limit the scope of the present disclosure to these particular embodiments. In the drawings, like reference numbers indicate identical or functionally similar elements.

In the following, the disclosure will be described in more detail with reference to the following figures:

FIG. 1 shows a layered structure for a shoe upper, such as for a sports shoe, according to some embodiments of the present disclosure.

FIG. 2 shows a lateral side view of a soccer shoe with a shoe upper being laceless according to some embodiments of the present disclosure.

FIG. 3 shows a lateral side view of a soccer shoe with a shoe upper being laceless according to some embodiments of the present disclosure.

FIG. 4 shows a top view of a shoe upper according to some embodiments of the present disclosure.

### DETAILED DESCRIPTION

In the following only some possible embodiments of the disclosure are described in detail. However, the present disclosure is not limited to these, and a multitude of other embodiments are applicable without departing from the scope of the disclosure. The presented embodiments can be modified in several ways and combined with each other whenever compatible and certain features can be omitted in so far as they appear dispensable. In particular, the disclosed embodiments can be modified by combining certain features of one embodiment with one or more features of another embodiment.

It is to be understood that not all features of the described aspects/embodiments must be present for realizing the technical advantages provided by the present disclosure. The disclosed aspects/embodiments can be modified by combining certain features of one aspect/embodiment with one or more features of another aspect/embodiment. Specifically, the skilled person will understand that features, and/or functional elements of one aspect/embodiment can be combined with technically compatible features, and/or functional elements of any other aspect/embodiment of the present disclosure given that the resulting combination falls within the definition of the present disclosure.

While the embodiments below are described primarily with reference to a shoe upper for a sports shoe such as a soccer shoe, the skilled person will recognize that the disclosure according to the disclosure can equally be applied in a plurality of different technical fields and/or use cases. For instance, other sports shoes for basketball, football, tennis, golf, cross-training, hiking, cycling, trailrunning or snowboarding are also conceivable. The expression “sports shoe such as a soccer shoe” means that athletic sports shoes are mentioned without use cases not directed to the athletic use like business shoes or chess shoes or house slippers.

Throughout the present figures and specification, the same reference numerals refer to the same elements. For the sake of clarity and conciseness, certain features, parts, elements, aspects, components and/or steps of certain embodiments are presented without undue detail where such detail would be apparent to the skilled person in the art considering the teachings herein and/or where such detail would obfuscate an understanding of more pertinent aspects of the embodiments.

As understood by the skilled person and/or to avoid redundancies, reference is also made to the explanations in the preceding sections, which also apply to the following detailed description. Further, not all features, parts, elements, aspects, components and/or steps are expressly indicated by reference signs for the sake of brevity and clarity. This particularly applies, where the skilled person recognizes that such features, parts, elements, aspects, components and/or steps are present in a plurality.

The term “forefoot region” of a shoe upper as used herein can refer to the front part of the shoe upper, e.g., the forefoot part of the shoe upper, encompassing the area from the ball of the foot to the toes. It is the part of the shoe upper that encounters the foot during propulsion and toe-off phases of the gait cycle.

The term “toe region” of a shoe upper as used herein can refer to the front part of the shoe upper that covers and protects the toes of the wearer. This area is usually designed to provide space and comfort for the toes, while also offering protection from external elements.

The term “midfoot region” of a shoe upper as used herein can refer to the central portion of the shoe upper that encompasses the area between the ball of the foot (forefoot) and the heel. It is located approximately in the middle of the foot's longitudinal axis.

The term “vamp region” of a shoe upper as used herein can refer to the portion of the shoe upper which covers the top of the foot and includes the area over the toes.

The term “supercritical foaming process” as used herein can refer to a technique used to create foams with specific properties by utilizing supercritical fluids where a supercritical fluid is a substance at a temperature and pressure above its critical point.

The term “lateral” of a shoe or shoe upper as used herein can refer to an outer side of the shoe or shoe upper. This outer side can be farther way from a centerline of the body of the wearer, when the shoe with the shoe upper is worn, compared to a medial side being an inner side of the shoe. This outer side can extend from a toe region to a heel region.

Unless otherwise stated, the term “approximately” as used in the present context may be understood mean to a great or significant extent or for the most part or essentially. In particular, manufacturing tolerances are included by this term. Hence, any values or arrangements described by using the term “approximately” may slightly deviate from the described values or arrangements (for example, within ten percent of the stated value).

The term “and/or” is only an association relationship describing associated objects and represents that three relationships can exist. For example, A and/or B can represent three conditions: i.e., independent existence of A, existence of both A and B and independent existence of B. In addition, the character “/” in the disclosure usually represents that previous and next associated objects form an “or” relationship.

The terms “upper,” “above,” “below,” “under,” and the like are used in the present disclosure to indicate a relative position in space are used for the purpose of facilitating explanation to describe a sole, a shoe, an element, a part, an object and/or a feature shown in the drawings relative to the relationship of another shoe, element, part, object and/or feature.

In one aspect, the objects of the present disclosure are at least partially solved by a shoe upper, in particular for a sports shoe, comprising a layered structure having (a.) a first layer, (b.) a second layer, and (c.) an intermediate foam layer between the first layer and the second layer, wherein the intermediate foam layer comprises a polyamide (PA) foam material.

In this manner, several properties like flexibility and cushioning can be improved. For example, PA foam is known for its high tensile strength and abrasion resistance, which can significantly enhance the overall durability of the footwear. The foam layer can help protect the other layers from wear and tear, thereby extending the lifespan of the shoe.

Further, the PA foam layer can provide additional structural support to the shoe upper, maintaining its shape and form over time. This can be particularly important in preventing deformation or sagging of the upper during extended use.

Moreover, PA foam offers excellent cushioning properties, contributing to the comfort of the wearer by absorbing shocks and impacts during movement. This can make the shoe more comfortable for prolonged wear, reducing foot fatigue.

Further, despite its strength, PA foam is lightweight, which helps reduce the overall weight of the shoe. Reduced weight of the shoe can contribute to improved performance, particularly in athletic footwear, by minimizing the energy required for movement.

Further, the PA foam layer can be tailored in terms of density and thickness to achieve specific performance characteristics, such as flexibility or rigidity in certain areas of the shoe. This tailoring can allow for a more customized fit and feel. Unlike other foam materials that can compress or lose their resilience over time, PA foam retains its properties longer, ensuring consistent performance throughout the life of the shoe.

In addition, the PA foam layer can also provide thermal insulation, helping to maintain a comfortable temperature inside the shoe. This can be beneficial in various weather conditions, keeping the foot warm in cold environments and cool in hot environments.

Moreover, PA foam can be engineered to have moisture-wicking properties, assisting in managing perspiration and keeping the foot dry. This can contribute to better hygiene and comfort.

In some embodiments, the PA foam layer can comprise perforations, such as micro-perforations, which can further improve the moisture-wicking properties (for example, by providing spaces through which moisture can be directed away from the foot of the wearer) and thereby assist in managing perspiration and keeping the foot dry.

In summary, incorporating an intermediate foam layer with a PA foam material between the first layer and the second layer in a shoe upper can provide a balanced combination of durability, comfort, lightweight construction, and thermal regulation, making it a superior choice for high-performance footwear.

In some embodiments of the shoe upper as described herein, the first layer is adapted to be turned inward of the shoe upper. In some embodiments of the shoe upper as described herein, the second layer is adapted to be turned outward of the shoe upper. In some embodiments of the shoe upper as described herein, the intermediate layer is adapted to provide stretchability and cushioning for ball contacts.

This multi-layered shoe upper design offers a blend of comfort, durability, flexibility, and performance, making it ideal for athletic footwear where both protection and functionality are paramount. For example, in embodiments in which the first layer is turned inward, the first layer can directly contact the foot, thereby providing a soft and comfortable interior surface. This design can reduce friction against the skin, thereby reducing or minimizing the risk of blisters and irritation, and enhance overall comfort during wear. In embodiments in which the second layer is turned outward, the second layer can face the external environment, thereby offering a robust and durable exterior. This second layer can protect the shoe upper from abrasions, scuffs, and environmental factors, such as dirt and moisture, thereby ensuring the shoe can maintain its appearance and longevity. Moreover, the intermediate layer (which can comprise the PA foam), designed to provide stretchability and cushioning, can enhance the shoe's performance during ball contacts. The stretchable nature of the foam can allows for better adaptability and flexibility during dynamic movements, while the cushioning can absorb impacts, thereby improving control and comfort when the foot contacts the ball. This can be particularly advantageous for sports like soccer, where precise ball control is crucial. Further, the stretchability of the intermediate layer can allow the shoe to conform to the natural movements of the foot, providing a snug yet flexible fit. This feature can be important for athletic footwear, where freedom of movement and foot flexibility can impact performance. Moreover, the cushioning provided by the intermediate layer can offer shock absorption, thereby protecting the foot from impacts during activities like running or jumping. This shock absorption can reduce the risk of injury and can enhance the comfort and safety of the wearer. The layered structure, with a cushioned intermediate layer, can also contribute to thermal insulation, keeping the foot warm in cooler conditions. Additionally, in embodiments in which the layers are designed with breathable materials, the shoe can manage moisture effectively, keeping the foot dry and comfortable. Further, the different layers can allow for customization in terms of materials and properties. For example, the outward layer could be made from a durable, water-resistant material, while the inward layer could be a soft, moisture-wicking material. This flexibility in design makes the shoe adaptable to various conditions and user preferences.

In some embodiments of the shoe upper as described herein, the first layer can form an innermost surface of the shoe upper. Placing the first layer as the innermost surface of the shoe upper can provide a soft and smooth interface directly against the foot. This can reduce the likelihood of irritation, chafing, or discomfort, particularly during extended wear. Further, the first layer can be designed with moisture-wicking properties, helping to draw sweat away from the skin and into the outer layers of the shoe. This can keep the foot dry, thereby improving comfort and reducing the risk of blisters. Breathable material as the innermost layer can promote air circulation around the foot, helping to regulate temperature and prevent overheating. This can contributes to overall foot health and comfort, particularly in warm conditions. Moreover, as the innermost layer, this layer can provide a protective barrier between the foot and other structural components of the shoe, such as stiffeners or reinforcement materials, ensuring that the foot is cushioned and shielded from any potentially harsh or rigid elements.

In some embodiments of the shoe upper as described herein, the second layer can form an outermost surface of the shoe upper. The second layer, being the outermost surface, can serve as the first line of defense against environmental elements such as abrasion, dirt, and moisture, thereby protecting the inner layers and extending the lifespan of the shoe. Further, the outermost layer can be designed with various textures, colors, and patterns, allowing for design flexibility and customization. This flexibility and customization can enhance the visual appeal of the shoe, making it more attractive to consumers. Moreover, if the second layer is treated with water-repellent or stain-resistant coatings, those coatings can help keep the shoe clean and dry in wet or dirty conditions, thereby improving the overall usability of the footwear. Further, depending on the material chosen for the second layer, the second layer can contribute to the breathability of the shoe, allowing air to circulate and keeping the foot cool and comfortable.

In some embodiments of the shoe upper as described herein, the layered structure can be arranged in a vamp region of the shoe upper. The vamp region, which covers the top of the foot and includes the area over the toes, can experience significant pressure and movement during use of the shoe upper. A layered structure with cushioning, such as foam, can provide additional comfort by distributing pressure evenly across the foot. Also, the vamp region can accommodate various foot shapes and sizes. For example, the layered structure described herein can allow the material to conform to the contours of the foot, thereby offering a snug and secure fit that can adapt to individual foot shapes. The vamp region can be subject to frequent bending and flexing. A reinforced layered structure can enhance the durability of the upper, thereby preventing premature wear and tear in this area. By incorporating materials that manage moisture effectively, the layered structure can also contribute to breathability in the vamp region. Breathability can help maintain foot comfort and reduce the risk of blisters or odors caused by trapped moisture. Moreover, the vamp region can play a role in controlling foot movement during walking or running. A well-designed layered structure can provide the necessary support to maintain stability, preventing excessive movement that could lead to discomfort or injury.

In some embodiments of the shoe upper as described herein, the layered structure can be arranged in a forefoot region of the shoe upper. The forefoot region can be subjected to pressure and impact during walking, running, and other activities. The layered structure described herein can provide cushioning and shock absorption in the forefoot region, thereby protecting the foot from injury and discomfort. By incorporating a layered structure with cushioning properties in the forefoot region, the shoe can provide energy return with each step. This can improve the efficiency of movement, making the shoe more responsive and enhancing performance, especially in sports footwear.

In some embodiments of the shoe upper as described herein, the layered structure can be arranged in a toe region of the shoe upper. The layered structure in the toe region can provide cushioning and protection against impacts, reducing the risk of injuries from stubbing or external forces. Further, the toe region can be subject to wear and tear, especially in activities like running or hiking. The layered structure can reinforce the toe region, thereby increasing the durability of the shoe and preventing premature wear.

In some embodiments of the shoe upper as described herein, the first layer can be a first textile layer. By incorporating a textile layer, manufacturers can produce a shoe upper that can balance breathability, comfort, and durability, while maintaining flexibility in both function and design. For example, a textile layer can enhance breathability, which allows air to circulate through the shoe, keeping the foot cool and dry. Further, a textile layer can allow for greater flexibility and adaptability to the foot's movements as compared to other materials. This flexibility can result in a more natural fit and better comfort, particularly in areas that experience a lot of flexion, such as the forefoot and midfoot.

In some embodiments of the shoe upper as described herein, the first layer can comprise a coating, a film, a synthetic leather, or a leather, or a combination thereof. This combination of materials can allow shoe designers to optimize the shoe for specific performance requirements, such as making the shoe more suitable for athletic, casual, or outdoor uses. For example, coatings, films, and synthetic or natural leather can offer wear resistance, protecting the shoe from environmental factors like water, dirt, or abrasion. These materials can extend the lifespan of the shoe, especially in high-stress areas like the toe or sides of the upper. Further, coatings and films can be engineered to provide water resistance, thereby preventing moisture from seeping into the shoe. Moisture prevention can be important for outdoor or athletic shoes where water exposure is common. Leather and synthetic leather naturally offer some level of water resistance as well. Moreover, the use of films and coatings can add lightweight structural support without the need for heavier materials. This can help maintain the form and fit of the shoe, while still allowing flexibility and movement in specific areas.

In some embodiments of the shoe upper as described herein, the second layer can comprise a second textile layer. The previous mentioned advantages for the first textile layer can also apply to the second textile layer.

In some embodiments of the shoe upper as described herein, the second layer can comprise a coating, a film, a synthetic leather, or a leather. The previous mentioned advantages for the first layer can also apply to the second layer.

In some embodiments of the shoe upper as described herein, one or more of the first layer or the second layer can comprise a fabric, such as a knitted fabric. Knitted fabrics can offer a more flexibility and stretchability as compared to woven fabrics. This flexibility can allow the shoe upper to conform more comfortably to the foot's shape, thereby providing a better fit and improved comfort. The open structure of knitted fabrics can enhances airflow and ventilation (e.g., breathability) within the shoe upper. This breathability can help in maintaining a cooler and more comfortable environment for the foot, thereby reducing moisture buildup and increasing overall foot comfort. The softness and elasticity of knitted fabrics can contribute to a more comfortable wearing experience. The fabric's ability to stretch and adapt to the foot's movements can reduce pressure points and friction, leading to less foot fatigue and discomfort.

In some embodiments, the knitted fabric can be weft-knitted or warp-knitted.

In some embodiments, one or more of the first textile layer and the second textile layer can comprise a woven and/or a non-woven textile. Woven fabrics are known for their durability and resistance to wear and tear. The interlacing of fibers in a woven fabric can provide greater strength compared to non-woven fabrics, which can help the layers resist abrasion and extend the lifespan of the shoe. The use of woven fabrics can provide additional reinforcement and support, thereby enhancing the overall performance and longevity of the shoe. Non-woven fabrics are often designed to be more breathable as compared to traditional woven fabrics. This breathability can improve air circulation within the shoe, helping to regulate temperature and reduce moisture buildup, which can enhance overall foot comfort. Further, non-woven fabrics can be lighter than woven alternatives due to their unique manufacturing process. This lighter weight can help in reducing the overall weight of the shoe, contributing to improved performance and comfort for the wearer.

In some embodiments of the shoe upper as described herein, one or more of the first layer and the second layer can comprise a PA material. This can deliver benefits such as enhanced durability, strength, moisture management, thermal regulation, and comfort, making it an advantageous choice for creating high-quality and high-performance footwear. For example, using PA in the textile layers can enhances the overall durability of the shoe upper, making it more resistant to wear and tear, which can extend the life of the footwear. Further, PA fabrics have good moisture-wicking properties, which help in managing sweat and keeping the foot dry. This moisture management can contribute to better comfort and hygiene, reducing the likelihood of foot odor and fungal infections. Furthermore, PA textiles are flexible and can be engineered to provide a comfortable fit. The material's ability to stretch and conform to the shape of the foot enhances the shoe's overall comfort, reducing pressure points and improving wearability. Moreover, having the same material class as the intermediate PA foam layer can enhance the manufacturing of the layered structure.

In some embodiments, one or more of the first layer and the second layer can comprise a polyurethane, PU, material and/or a thermoplastic polyurethane, TPU, material.

In some embodiments of the shoe upper as described herein, one or more of the first textile layer and the second textile layer can comprise a thickness between 0.05 mm and 1.0 mm, between 0.1 mm and 0.8 mm between 0.2 mm and 0.6 mm, or approximately 0.3 mm. Textile layers in this thickness range can contribute to effective breathability, which can help in moisture management and temperature regulation. This thickness is sufficient to allow air circulation while still providing adequate coverage and protection. A textile layer thickness within this range can allow for a balance between flexibility and support. Thicker layers can provide more cushioning and support, while thinner layers can provide better flexibility and breathability. The thickness of approximately 0.3 mm offers a good compromise between these two factors, enhancing comfort without compromising movement. Further, this thickness range can provide sufficient durability to withstand wear and tear while maintaining the overall integrity of the shoe upper. This thickness range can help prevent premature damage or fraying, extending the lifespan of the footwear.

In some embodiments of the shoe upper as described herein, the intermediate foam layer can comprise a thickness between 0.5 mm and 1.5 mm, between 0.7 mm and 1.2 mm, or approximately 1.0 mm. The specified thickness ranges can ensure that the intermediate foam layer delivers cushioning, support, flexibility, and durability while maintaining a lightweight design. For example, the thickness ranges offer a balance between cushioning and support. The thickness ranges can provide sufficient cushioning to absorb impacts and enhance comfort without compromising the structural integrity of the shoe. This thickness range can help to achieve effective shock absorption while maintaining responsiveness. At this thickness, the intermediate foam layer can maintain sufficient flexibility to adapt to the movement of the foot. This flexibility is crucial for athletic and casual footwear, allowing for natural foot motion while providing support. Moreover, the thickness ranges can ensure that the foam layer adds minimal weight to the shoe. This can be important for performance footwear, where reducing weight can improve speed and agility without sacrificing comfort or support.

In some embodiments of the shoe upper as described herein, the intermediate foam layer can comprise a thickness between 1.0 mm and 7.0 mm, between 2.5 mm and 6.0 mm, a thickness of approximately 4.5 mm, or a thickness of approximately 6.0 mm.

In some embodiments of the shoe upper as described herein, the material of the intermediate foam layer can be manufactured by a supercritical foaming process. A supercritical foaming process is a technique used to create foams with specific properties by utilizing supercritical fluids where a supercritical fluid is a substance at a temperature and pressure above both its critical temperature and its critical pressure. Thus, the supercritical foaming process allows for precise control over the foam's structure and properties, resulting in a material with improved mechanical properties, such as higher strength-to-weight ratios and better impact resistance. This contributes to the overall durability and performance of the intermediate layer. Further, supercritical foaming typically produces a more uniform cell structure as compared to traditional foaming methods. This uniformity can enhance the consistency of the foam's cushioning and support properties, leading to more predictable and reliable performance in footwear. The fine and uniform cell structure of foam produced via supercritical foaming can provide desired thermal insulation properties. This can help in maintaining a comfortable temperature inside the shoe, contributing to enhanced wearer comfort across different environments. The supercritical foaming process can create foam with improved breathability as compared to traditional foaming methods, as the uniform pore structure can facilitate better air circulation. This can help in managing moisture and temperature within the shoe, keeping the foot dry and comfortable. In summary, using a material for the intermediate layer that is manufactured by a supercritical foaming process provides several advantages, including enhanced mechanical properties, uniform cell structure, lightweight characteristics, and improved breathability, all of which contribute to performance, comfort, and sustainability in footwear.

In some embodiments of the shoe upper as described herein, the shoe upper further can comprise a foil layer on the second layer adapted to provide a coating for the shoe upper. Adding a foil layer to the second layer of a shoe upper can provide a range of benefits, including improved durability, water resistance, aesthetic appeal, and ease of maintenance, while also enhancing the overall functionality and performance of the shoe. The foil layer acts as a protective coating, increasing the overall durability of the shoe upper. The foil layer can shield the underlying textile from wear, tear, and environmental factors such as moisture, UV rays, and abrasion. Moreover, a foil layer can provide effective water resistance, preventing water from penetrating through the shoe upper. This keeps the wearer's feet dry and comfortable, especially in wet conditions. Moreover, the foil layer can enhance the visual appeal of the shoe upper by adding a sleek, polished finish or a unique texture. This can elevate the design and give the shoe a more premium or fashionable look. Further, the foil layer can make the shoe upper easier to clean and maintain. Its smooth surface repels dirt and stains, allowing for easier wiping or washing compared to untreated textile surfaces. Further, depending on the type of foil used, the foil can be engineered to maintain or enhance the breathability of the shoe upper. Advanced foil materials can offer a balance between protection and ventilation, ensuring comfort. Moreover, modern foil materials are designed to be flexible, ensuring that the shoe upper retains its pliability and does not compromise the comfort or fit of the shoe.

In some embodiments of the shoe upper as described herein, the foil layer can comprise a thermoplastic polyurethane, TPU, material. TPU is known for its high durability and resistance to abrasion. The foil layer can provide enhanced protection against wear and tear, extending the lifespan of the product. TPU also maintains flexibility even at low temperatures, which contributes to overall comfort. The foil layer can bend and stretch with the movement of the shoe, providing a comfortable fit without compromising on durability. TPU has excellent resistance to chemicals, oils, and fats. This makes the foil layer more resilient in environments where the shoe might be exposed to such substances, ensuring longevity and maintaining the appearance of the shoe. TPU is also inherently water-resistant, which helps in preventing water ingress and keeping the shoe's internal materials dry. This is particularly advantageous for footwear used in wet conditions. TPU has a high degree of elasticity and resilience, which contributes to improved shock absorption and impact resistance. This enhances the performance characteristics of the shoe, particularly in high-impact or athletic use. Moreover, TPU remains stable across a wide range of temperatures, maintaining its properties and performance in various environmental conditions. This ensures that the shoe performs consistently in both hot and cold conditions.

In some embodiments of the shoe upper as described herein, the foil layer comprises a thickness between 0.01 mm and 0.1 mm, between 0.02 mm and 0.07 mm, or a thickness of approximately 0.05 mm. A foil thickness in this range can ensure that the material is flexible enough to conform to different shapes and surfaces without being too rigid or cumbersome. This is particularly advantageous in applications where the foil needs to adapt to complex geometries or movements. The specified thickness range provides a balance between durability and weight. Foils that are too thin might be prone to tearing or punctures, while those that are too thick could be unnecessarily heavy or stiff. The chosen thickness range ensures the foil has adequate strength while remaining practical for its intended use. Further, at the thickness specified, the foil can effectively serve as a barrier against various environmental factors such as moisture, gases, or chemicals, depending on the material. This level of thickness is typically sufficient to provide effective protection while maintaining lightness. The chosen thickness also ensures effective thermal or electrical insulation if required, without compromising on the overall design and functionality of the product.

In some embodiments of the shoe upper as described herein, the foil layer can be extruded. Extrusion can allow for the creation of a foil layer with a uniform thickness and consistent material properties throughout the entire layer. This can ensure that the foil layer performs consistently, avoiding weak spots or variations in thickness that could affect the product's overall quality and functionality. The extrusion process can produce a smooth and high-quality surface finish on the foil layer. This can be advantageous for applications where appearance and surface texture are important, such as in consumer products or high-visibility components. Extruded foil layers can be produced in various shapes and sizes, including complex geometries. This flexibility allows for the design of components that fit precisely within the desired application or product, providing more design options.

In some embodiments of the shoe upper as described herein, the foil layer can comprise a hardness between 40 and 90 Shore A, between 50 and 70 Shore A, or approximately 65 Shore A. A foil layer with this hardness range can provide a desirable combination of flexibility, durability, impact resistance, and aesthetic quality, making it suitable for a wide range of applications while ensuring consistent and reliable performance. For example, foil materials within the hardness range can offer good wear resistance without being too rigid. This level of hardness ensures that the foil can withstand abrasion and physical stress over time, contributing to the longevity of the product.

In some embodiments of the shoe upper as described herein, the shoe upper can comprise a resin layer as an outermost layer. In some embodiments, the resin layer can comprise a polyurethane material. A resin layer made of polyurethane as the outermost layer can provide a combination of durability, flexibility, water resistance, and ease of maintenance, making it an excellent choice for enhancing the performance and longevity of a product. For example, PU is known for its high durability and resistance to wear and tear. As the outermost layer, PU resin can provide a robust protective barrier that can withstand daily use and harsh environmental conditions, extending the lifespan of the product. Further, PU resin offers excellent abrasion resistance, which can be crucial for applications where the surface is exposed to friction and rough surfaces. This can help prevent the outer layer from deteriorating or showing signs of wear, maintaining the aesthetic and functional integrity of the product. Moreover, PU resins can be formulated to provide a flexible yet supportive layer. This flexibility can help the product conform to the shape of the foot or other parts, enhancing comfort and reducing the likelihood of discomfort or pressure points. Moreover, with PU resin as outermost layer, a variety of different colors and various further visual effects can be achieved. For example, a surface texture can be provided by debossing the PU resin layer. Further, the resin layer can be applied in a liquid state by rolling the polyurethane material onto the adjacent layer of the layered structure.

In some embodiments of the shoe upper as described herein, the first layer and/or second layer can be a resin layer made of polyurethane. Due to its durability, flexibility and abrasion resistance, a resin layer made of PU as the first and/or second layer can provide sufficient protection as well as comfort.

In some embodiments of the shoe upper as described herein, the resin layer can comprise a thickness between 0.01 mm and 0.1 mm, between 0.02 mm and 0.07 mm, or approximately 0.05 mm. A resin layer with a thickness within the disclosed ranges can provide numerous technical advantages, including precise control, enhanced bonding, minimal weight addition, improved flexibility, cost efficiency, optimized cure time, and consistent performance. For example, a resin layer with a controlled thickness, such as the mentioned thickness ranges, allows for precise application and can ensure uniform coverage. This level of control can help in achieving consistent performance across the entire surface, which can be crucial for applications where even distribution of material properties is essential. Further, a resin layer with a thickness within the disclosed ranges can support bonding between different layers or components. The resin can ensure strong adhesion without adding excessive bulk, which can improve the overall structural integrity and durability of the final product. By using a resin layer with a thickness within the disclosed ranges, material usage can be decreased, leading to cost savings in resin procurement and processing. This also contributes to more efficient production processes. Moreover, thinner resin layers often cure faster as compared to thicker layers, reducing the overall processing time and improving production efficiency. This can be advantageous in manufacturing environments where time is a critical factor.

In some embodiments of the shoe upper as described herein, one or more of the layers can be joined by adhesive films such as polyamide, PA, hotmelt adhesive films. Employing polyamide hotmelt adhesive films for joining layers offers a combination of strong, durable bonds, lightweight construction, and efficient manufacturing, while also maintaining aesthetic quality and providing resistance to environmental factors. For example, PA hotmelt adhesive films can provide a strong and durable bond between layers. This bond can ensure that the layers remain securely attached throughout the product's lifecycle, even under stress or strain. Further, the use of PA hotmelt adhesive films can contribute to the overall durability of the product. Polyamide is known for its high mechanical strength and resistance to wear, which can help maintain the integrity of the layered structure. Further, hotmelt adhesives, including polyamide-based ones, are flexible and can conform to the shapes of the layers they join. This flexibility is beneficial in applications where the bonded layers need to move or flex without compromising the bond.

In some embodiments of the shoe upper as described herein, the layered structure can be arranged in a midfoot region and/or a tongue region of the shoe upper. Placing the layered structure with polyamide foam in the midfoot and/or tongue regions of the shoe upper provides a range of benefits, including enhanced support, improved comfort, pressure point relief, and increased durability. This strategic placement addresses key areas of the foot that experience significant stress and wear, contributing to a better overall footwear experience. For example, the layered structure in the midfoot region can provide additional support and stability to the arch and midfoot area. This helps in evenly distributing the pressure exerted during movement and can reduce the risk of foot fatigue and injuries. Further, by incorporating the foam layer in these regions, the shoe can offer enhanced cushioning where it is needed. The midfoot area experiences significant stress during activities, and the cushioning helps absorb impacts, providing a more comfortable experience. In the tongue region, the layered structure can improve the fit of the shoe by offering additional padding. This helps in reducing pressure points and discomfort caused by the laces or the shoe's internal structure, enhancing overall comfort. The foam layer can act as a buffer, reducing or minimizing pressure points that are common in the midfoot and tongue areas. This is especially beneficial in limiting or preventing blisters and other foot ailments that arise from friction or pressure. For sports and athletic footwear, improved support and cushioning in the midfoot region can contribute to better performance by enhancing foot control and reducing the impact of high-intensity activities.

In some embodiments of the shoe upper as described herein, the layered structure can comprise a profile element, such as by debossing. The inclusion of a profile element like a debossed profile element in a layered structure can provide several advantages, including improved grip, increased structural integrity, functional design benefits, and durability. These benefits can contribute to both the performance and appeal of the product. For example, debossing allows for intricate and precise patterns or logos to be permanently embedded into the material. This not only adds a unique and visually appealing design element to the product but also enhances its overall appearance and branding opportunities. Further, a debossed profile element can provide additional grip and traction. The raised or recessed patterns created by debossing can increase surface contact and friction with the ground, improving stability and reducing the risk of slipping. Moreover, the debossed profile can contribute to the structural strength and stability of the layered material. By creating raised or recessed areas, the profile element can help distribute stress and forces more evenly, reducing the likelihood of material deformation or failure under pressure. The debossing process often involves compressing the material, which can increase its density and resistance to wear. This added durability helps maintain the integrity of the design elements over time, even with regular use. Debossed elements can also serve as functional embellishments, such as indicators or guides for the user. For instance, in a shoe, debossed patterns could guide the placement of the foot or indicate pressure points for optimal comfort.

In some embodiments, there can be several types of profile elements which can be arranged on the outermost layer. For example, there can be rubber protrusions and/or printed protrusions that can be adhered to the outermost layer. There can also be several profile elements of the different types to achieve the above-mentioned advantages.

In some embodiments of the shoe upper as described herein, the shoe upper can comprise multiple apertures in the intermediate foam layer. Having multiple apertures in an intermediate foam layer can offer multiple benefits, including enhanced breathability, reduced weight, improved flexibility, optimized cushioning, better thermal regulation, and effective moisture management, all of which can contribute to a more comfortable, efficient, and sustainable product. For example, apertures in the intermediate foam layer can facilitate airflow, improving ventilation within the shoe. This helps in reducing moisture buildup and heat accumulation, keeping the foot cooler and drier, which can be beneficial for athletic and everyday footwear. Further, the inclusion of apertures can reduce the overall weight of the foam layer by removing excess material. This lightweight design can improve comfort and performance, particularly in high-performance athletic footwear where minimizing weight is crucial. Moreover, the apertures can enhance the flexibility of the foam layer by allowing it to bend and conform more easily to the shape of the foot. This can result in a more comfortable and adaptive fit, reducing pressure points and improving overall wearability. Further, by strategically placing apertures in the intermediate foam layer, the intermediate foam layer can offer targeted cushioning and support. The design can be optimized to provide better shock absorption and impact protection in specific areas of the foot, improving overall comfort and performance. By using apertures to reduce the volume of foam required, manufacturers can achieve cost savings and reduce material consumption. This can contribute to more sustainable production practices and lower production costs.

As used herein, the term “multiple” can refer to a number that can be more than one and can imply a larger or indefinite number to achieve the mentioned technical effects.

In some embodiments of the shoe upper as described herein, the first layer and/or the second layer can comprise multiple apertures. Incorporating multiple apertures into the layers of a shoe upper can provide multiple advantages, including improved breathability, moisture management, weight reduction, flexibility, and overall comfort, while also allowing for innovative design possibilities. For example, incorporating apertures into the layers can improve airflow and ventilation within the shoe. This helps in maintaining a comfortable internal temperature by allowing heat and moisture to escape, reducing the likelihood of overheating and excessive sweating. Moreover, the apertures can facilitate better moisture evaporation from the foot. This contributes to enhanced hygiene and comfort by helping to keep the foot dry and reducing the risk of bacterial growth and odor. Integrating apertures directly into the layers can lead to a reduction in the overall weight of the shoe. For example, fewer or smaller material sections can be required to achieve the same structural support, which can enhance the shoe's performance, especially in athletic applications. Strategically placed apertures can reduce the amount of textile material needed, leading to potential cost savings in material usage without compromising the structural integrity of the shoe upper.

In some embodiments of the shoe upper as described herein, the first layer, the second layer and the intermediate layer can form a single piece structure extending from a top surface of the shoe upper to a bottom surface of the shoe upper. The single piece structure can completely encircle a foot of a wearer when in use. The single piece structure can be arranged in a forefoot region of the shoe upper. Embodiments disclosed herein can allow the PA foam material to provide a cushioning effect beneath the foot, for example between the foot and the more rigid sole and/or sole plate, but without adding too much compressibility and material, which can be disadvantageous for stability during soccer ball control. Further, the single piece structure can encircle the foot completely and thus offer a sock-like fit. This design can reduce or minimize pressure points and create a snug, secure fit, enhancing overall comfort for the wearer. By fully encompassing the foot, the structure can provide uniform pressure distribution, reducing hotspots or irritation. Locating the single-piece structure in the forefoot region can ensure flexibility and responsiveness where it can be needed. This can improve athletic performance by providing better energy transfer and natural movement.

In some embodiments of the present disclosure, the objects are at least partially solved by a shoe upper, such as for a sports shoe, comprising a PA foam layer extending from a top surface of the shoe upper to a bottom surface of the shoe upper to encircle a foot of the wearer. In other words, the PA foam layer can extend along the sides and top of the foot of a wearer.

In some embodiments of the shoe upper as described herein, the PA foam layer can comprise a thickness between 1.0 mm and 7 mm, between 2.5 mm and 6.0 mm, a thickness of approximately 4.5 mm or a thickness of approximately 6.0 mm.

In some embodiments of the shoe upper as described herein, the PA foam layer can comprise a first part in the forefoot area and a second part in the heel area of the shoe upper. The second part can be thicker than the first part.

In some embodiments of the shoe upper as described herein, the first part can comprise a thickness between 1.0 mm and 5.0 mm, or approximately 4.5 mm. The second part can comprise a thickness between 1.0 mm and 7 mm, or approximately 6.0 mm.

The thinner first part in the forefoot can provide improved flexibility, breathability, weight reduction, and ground feel, making it ideal for both performance and comfort. For example, the forefoot is the most active part of the foot during walking, running, and other movements so that a thinner upper layer can allow for greater flexibility, enabling the shoe to move and bend naturally with the foot, improving overall performance. Further, thinner materials can contribute to a lighter shoe, which can be important in sports and athletic footwear, where reducing weight can improve speed and endurance.

The advantage of the thicker second part can include larger cushioning effect for the side walls of the heel area and the bottom of the heel so that a larger dampening effect in the heel area can be achieved during running and the corresponding rear-foot and ankle portion of the foot can be comfortably enclosed by the shoe upper.

In some embodiments of the shoe upper as described herein, the first part and the second part can be connected by thermally or adhesively bonding. In this way, a stitched seam on the inside of the shoe upper in the heel area can be avoided. Additionally or alternatively, the first part and the second part can be connected by stitching, for example zig-zag stitching.

In some embodiments of the shoe upper as described herein, the first part can comprise at least two portions that can be bonded or connected as mentioned before.

In some embodiments of the shoe upper as described herein, the PA foam layer can be debossed, e.g., heat-pressed, to provide lower thickness as previously described. This lower thickness can reduce the manufacturing efforts for bonding/connecting two or more parts of the shoe upper with the PA foam layer.

In this way, a single (or continuous) piece structure can be provided, as previously described.

In some embodiments, the shoe upper comprising the PA foam layer at least partially encircling the foot of the wearer can also be combined with one or more of the previous features of the shoe upper comprising a layered structure having a first layer, a second layer, and an intermediate foam layer between the first layer and the second layer, wherein the intermediate foam layer comprises a polyamide, PA, foam material. Here, the intermediate foam layer can be similar to the described PA foam layer.

In some embodiments of the present disclosure, the objects are at least partially solved by a shoe upper, such as for a sports shoe, comprising a PA foam layer. The shoe upper can be combined with a first layer and/or a second layer as defined in one or more of the previous embodiments. It is also conceivable that the shoe upper can only comprise the PA foam layer and no further layers. The shoe upper can also be combined with one or more of the previous features of the shoe upper comprising a layered structure having a first layer, a second layer, and an intermediate foam layer between the first layer and the second layer, wherein the intermediate foam layer comprises a PA foam material.

The PA foam layer can provide the advantages as described for the previous embodiments. In particular, the PA foam layer can provide sufficient structural support to the shoe upper while providing excellent cushion properties, contributing to the comfort of the wearer by absorbing shocks and impacts during movement. Further, the stretchable nature of the foam can allow for better adaptability and flexibility during dynamic movements, as well as for better adaptability of the upper to the wearer's foot shape, resulting in a snug fit and a comfortable wearing experience for the wearer.

In some embodiments of the shoe upper as described herein, the PA foam layer can be arranged in a forefoot region and/or a midfoot region of the shoe upper. The forefoot region and midfoot region can experience significant pressure and movement. The cushioning of a PA foam layer can provide additional comfort by distributing pressure evenly across the foot. Also, the forefoot region and midfoot region need to accommodate various foot shapes and sizes. A PA foam layer can allow the material to conform to the contours of the foot, offering a snug and secure fit that can adapt to individual foot shapes.

In some embodiments of the shoe upper as described herein, the material of the PA foam layer can be manufactured by a supercritical foaming process, as mentioned before. The supercritical foaming process allows for precise control over the foam's structure and properties, resulting in a material with improved mechanical properties, such as higher strength-to-weight ratios and better impact resistance. This can contribute to the overall durability and performance of the PA foam layer. Further, supercritical foaming typically produces a more uniform cell structure compared to traditional foaming methods. This uniformity can enhance the consistency of the foam's cushioning and support properties, leading to more predictable and reliable performance in footwear. The fine and uniform cell structure of foam produced via supercritical foaming often provides superior thermal insulation properties. This can help in maintaining a comfortable temperature inside the shoe, contributing to enhanced wearer comfort across different environments. The supercritical foaming process can create foam with improved breathability, as the uniform pore structure can facilitate better air circulation as compared to foams manufactured using traditional foaming methods. This can help in managing moisture and temperature within the shoe, keeping the foot dry and comfortable. In summary, using a material for the PA foam layer that is manufactured by a supercritical foaming process can provide several advantages, including enhanced mechanical properties, uniform cell structure, lightweight characteristics, and improved breathability, all of which can contribute to performance, comfort, and sustainability in footwear.

In some embodiments, the PA foam layer can comprise polyamide 11 (PA 11) polyamide 12 (PA12) and/or polyether block amide (PEBA).

In some embodiments of the present disclosure, the objects are at least partially solved by a sports shoe comprising a shoe upper as described in any the embodiments in here.

Since the sports shoe can comprise the shoe upper as described in any of the embodiments described herein, it is understood that the technical properties shown or described for the shoe upper, and the advantages and the improvements over the state of the art can be likewise applicable to the sports shoe with the upper and vice versa.

In some embodiments of the shoe as described herein, the sports shoe can be a soccer shoe. The upper part of a soccer shoe can be crafted to offer improved ball control. Features such as textured surfaces or grip-enhancing materials can help players better control and manipulate the ball, facilitating more precise passing, dribbling, and shooting.

In some embodiments of the shoe as described herein, the soccer shoe can be laceless. By eliminating laces, the shoe can provide a cleaner and more consistent striking surface for the ball. This can improve accuracy and control when kicking, passing, or shooting, as there are no laces to interfere with ball contact. Without laces, there is a lower risk of injury from lace-related issues, such as laces coming undone and causing tripping, or laces putting pressure on the foot. Additionally, the laceless design can reduce or minimize the risk of lace-related abrasions or discomfort. Overall, laceless soccer shoes offer a combination of functional and performance benefits, making them an attractive option for players seeking a blend of comfort, style, and enhanced on-field performance.

In some embodiments of the sports shoe as described herein, the intermediate foam layer can be arranged only in a throat region of the shoe upper. By placing the foam layer only in the throat region, which is the area around the opening of the shoe where the foot enters, the cushioning can be concentrated where it may be most needed. This can enhance comfort during the initial foot entry and while securing the shoe, providing a plush and supportive feel. The throat region often experiences the most stress from foot movement and adjustments. The foam layer can help in accommodating varying foot shapes and providing a snug fit, which reduces pressure points and enhances overall comfort. Moreover, limiting the foam layer to the throat region can help in keeping the overall weight of the shoe lower as compared to having foam throughout the entire upper. This can improve performance, especially in athletic or running shoes, where weight reduction is crucial.

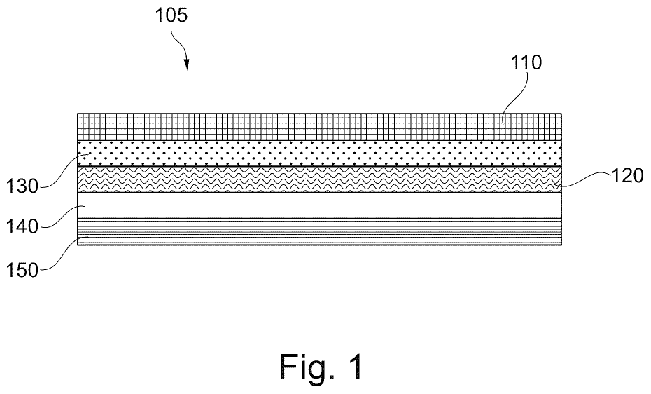

FIG. 1 shows a layered structure 105 for a shoe upper, such as for a sports shoe, according to an embodiment of the present disclosure.

The layered structure 105 will be explained from the inside to the outside of a shoe upper. In some embodiments, the layered structure 105 can comprise a first layer 110. In some embodiments, the first layer 110 can comprise a first textile, but other materials like a coating, a film, a synthetic leather or a leather are also conceivable. The first layer 110 can be adapted to be turned inward of the shoe upper. In some embodiments, the first layer 110 can form an innermost surface of the shoe upper. For example, the first layer 110 can refer to the interior side of the shoe upper, which directly contacts the foot when the shoe is worn.

The layered structure 105 can comprise a second layer 120. In some embodiments, the second layer 120 can comprise a second textile, but other materials like a coating, a film, a synthetic leather or a leather are also conceivable. In some embodiments, the second layer 120 can be adapted to be turned outward of the shoe upper. In some embodiments, the second layer 120 can form an outermost surface of the shoe upper. For example, the second layer 120 can refer to the outermost layer or the external surface of the shoe upper so that no further layer is then arranged on top of it. In some embodiments, the second layer 120 can form an intermediate layer such that further layers can be arranged on top of it.

The first layer 110 and the second layer 120 can comprise a polyamide, PA, material. As explained before, using PA in the first layer 110 and the second layer 120 can enhance the overall durability of the shoe upper, making it more resistant to wear and tear, which extends the life of the footwear. Other materials that can be used can include a polyurethane, PU, material and/or a thermoplastic polyurethane, TPU, material.

In some embodiments, the first layer 110 and the second layer 120 can comprise a thickness between 0.05 mm and 1.0 mm, between 0.1 mm and 0.8 mm, between 0.2 mm and 0.6 mm, or approximately 0.3 mm. These values contribute to effective breathability, which helps in moisture management and temperature regulation, and provide an optimal balance between flexibility and support. In some embodiments, both the first layer 110 and the second layer 120 can comprise a thickness of approximately 0.3 mm.

In some embodiments, the first layer 110 and the second layer 120 can comprise a fabric, such as a knitted fabric. As explained above, the first layer 110 and/or the second layer 120 can comprise a woven and/or a non-woven textile. Other materials can include those as mentioned above.

In some embodiments, the layered structure 105 can comprise an intermediate foam layer 130 between the first layer 110 and the second layer 120, wherein the intermediate foam layer 130 can comprise a PA foam material. As explained above, a PA foam material can provide high tensile strength and abrasion resistance as well as additional structural support to the shoe upper. For example, polyamide 11, PA 11, can be used as a raw material for the foaming process of the PA foam material. In another example, PA 12 could be used. In another example, polyether block amide, PEBA, could be used. Another material could be thermoplastic polyester elastomer, TPEE, foam.

Alternatively or additionally, the intermediate foam layer 130 can comprise a thermoplastic polyurethane, TPU, foam instead or together with the PA foam.

In some embodiments, the intermediate foam layer 130 can comprise a thickness between 0.5 mm and 1.5 mm, between 0.7 mm and 1.2 mm, or a thickness of approximately 1.0 mm.

In some embodiments, the material of the intermediate foam layer 130 can manufactured by a supercritical foaming process, wherein foams can be created with specific properties by utilizing supercritical fluids. Thus, the overall durability and performance of the intermediate layer is improved. For example, polyamide 11, PA 11, can be used as raw material. PA 11 is a type of nylon, and RILSAN® is the trademarked name used by Arkema. In another example, PA 12 could be used. In another example, polyether block amide, PEBA, could be used.

in some embodiments, the three layers disclosed, namely the first layer 110, the second layer 120 and the intermediate foam layer 130, can be laminated together on a sheet roll.

In some embodiments, the layered structure 105 can comprise a foil layer 140. In some embodiments, the foil layer 140 can be disposed on the second layer 120. The foil layer 140 can be adapted to provide a coating for the shoe upper, for example when the foil layer 140 is applied as the outermost layer. A “coating” can refer to a thin layer of material that is applied to the surface of the shoe upper to enhance its properties or to give it specific characteristics like waterproofing, durability, breathability, protection from degradation due to exposure to sunlight (UV radiation), or repellency of dirt and stains.

In some embodiments, the foil layer 140 can comprise a thermoplastic polyurethane, TPU, material, which has high durability and resistance to abrasion. The advantage of using the TPU material for the foil layer 140 is that TPU can be used for different kinds of coatings, such as, e.g., printed layers, or protrusions of any kind. Furthermore, the foil layer 140 as outermost layer can be beneficial for bonding the shoe upper to the sole, which is usually a relatively stiff sole for soccer shoes. Another material that could be used for the foil layer 140 is PA.

In some embodiments, the foil layer 140 can comprise a thickness between 0.01 mm and 0.1 mm, a thickness between 0.02 mm and 0.07 mm, or a thickness of approximately 0.05 mm.

In some embodiments, the foil layer 140 can be extruded. Other manufacturing processes like coating processes (for example, depositing very thin layers of metal or other material(s) onto a substrate) are also conceivable.

In some embodiments, the foil layer 140 can comprise a hardness between 40 and 90 Shore A, between 50 and 70 Shore A, or approximately 65 Shore A.

In some embodiments, the layered structure 105 can comprise a resin layer 150 as an outermost layer comprising a polyurethane, PU, material. As mentioned, PU resin offers excellent abrasion resistance.

In some embodiments, the resin layer 150 can comprise a thickness between 0.01 mm and 0.1 mm, a thickness between 0.02 mm and 0.07 mm, or a thickness of approximately 0.05 mm.

In some embodiments, the five layers 110, 120, 130, 140, and 150 can be joined by adhesive films like PA hotmelt adhesive films. Other materials that can be used to join the five layers 110, 120, 130, 140, and 150 could be TPU hotmelt adhesive films or PU hotmelt adhesive films.

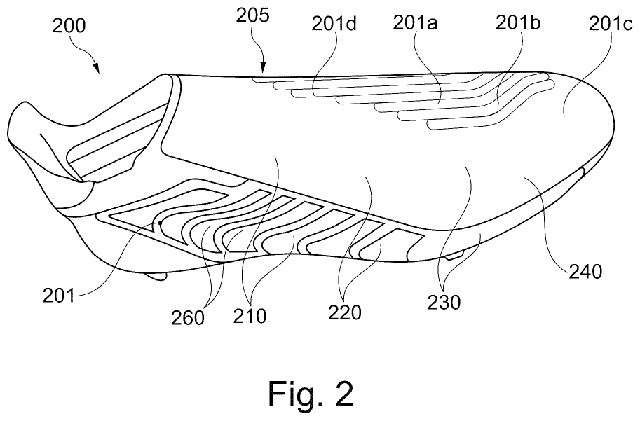

FIG. 2 shows a lateral side view of a soccer shoe 200 with a shoe upper 201 being laceless according to an embodiment of the present disclosure.

In some embodiments, the shoe upper 201 can comprise a layered structure 205 comprising a first layer 210, a second layer 220, and an intermediate foam layer 230 between the first layer 210 and the second layer 220, wherein the intermediate foam layer 230 comprises a PA foam material. These layers can be similar to the first layer 110, the second layer 120, and the intermediate foam layer 130 with respect to FIG. 1.

The first layer 210 can comprise a textile, but other materials like a coating, a film, a synthetic leather or a leather are also conceivable.

The second layer 220 can comprise a textile, but other materials like a coating, a film, a synthetic leather or a leather are also conceivable.

In some embodiments, the layered structure 205 can comprise a foil layer 240 similar to the foil layer 140 with respect to FIG. 1.

In some embodiments, the layered structure 205 can comprise a resin layer 250 similar to the resin layer 150 with respect to FIG. 1.

The layered structure 205 can be similar to the layered structure 105 of FIG. 1. For example, the innermost layer of the layered structure 205 can comprise the first layer 210, followed by the intermediate foam layer 230 disposed on the first layer 210, and the second layer 220 disposed on the intermediate foam layer 230. In some embodiments, the foil layer 240 can be disposed on the second layer 220. In some embodiments, the resin layer 250 can be disposed on the foil layer 240. Thus, the outermost layer of the layered structure 205 can be the second layer 220 (in embodiments in which the foil layer 240 and the resin layer 250 are not implemented), the foil layer 240 (in embodiments in which the resin layer 250 is not implemented), or the resin layer 250.

In some embodiments, the layered structure 205 can be arranged in a vamp region 201a, a forefoot region 201b, and/or a toe region 201c of the shoe upper 201. In some embodiments, the layered structure 205 can comprise the foil layer 240 such that the vamp region 201a, the forefoot region 201b, and/or the toe region 201c can be covered by the foil layer 240. In some embodiments, the layered structure 205 can comprise the resin layer 250 such that the vamp region 201a, the forefoot region 201b, and/or the toe region 201c can be covered by the resin layer 250. Alternatively, the foil layer 240 and/or the resin layer 250 can be omitted in these regions. As explained above, the layered structure 205 in these specific regions of the shoe upper 201 can provide additional cushioning and protection against impacts, reducing the risk of injuries from stubbing or external forces.

As the shoe upper 201 is laceless, the layered structure 205 can be arranged in a throat region 201d of the shoe upper 201. For a shoe upper with laces, the layered structure 205 can be arranged in a tongue region of the shoe upper 201. As mentioned before, the foil layer 240 and/or the resin layer 250 can be omitted in these regions for a shoe upper with laces.

In some embodiments, the shoe upper 201 can comprise multiple apertures 260 in the intermediate foam layer 230. As shown in FIG. 2, the apertures 260 are on the lateral side of the midfoot region of the shoe upper 201. The apertures 260 can provide enhanced breathability, reduced weight, improved flexibility, optimized cushioning, better thermal regulation, and effective moisture management. “Multiple” can refer to a number that can be more than one and often implies a larger or indefinite number to achieve the mentioned technical effects.

In some embodiments, the shoe upper 201 can comprise apertures 260 in the first textile layer 210 and/or the second textile layer 220.

Alternatively or additionally, the apertures 260 can be arranged on the medial side of the shoe upper 201.

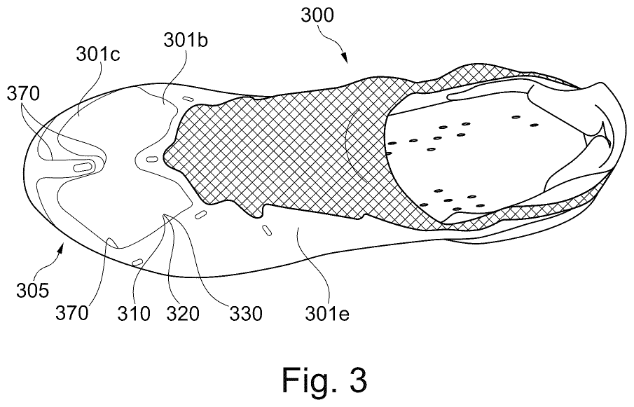

FIG. 3 shows a lateral side view of a sports shoe 300 with a shoe upper 301 being laceless according to an embodiment of the present disclosure.

In some embodiments, the shoe upper 301 can comprise a layered structure 305 comprising a first layer 310, a second layer 320, and an intermediate foam layer 330 between the first layer 310 and the second layer 320, wherein the intermediate foam layer 330 comprises a PA foam material. These layers can be similar to the first layer 110, the second layer 120, and the intermediate foam layer 130 with respect to FIG. 1 as well as to the first layer 210, the second layer 220, and the intermediate foam layer 230 with respect to FIG. 2.

The first layer 310 can comprise a textile, but other materials like a coating, a film, a synthetic leather or a leather are also conceivable.

The second layer 320 can comprise a textile, but other materials like a coating, a film, a synthetic leather or a leather are also conceivable.

In some embodiments, the layered structure 305 can comprise a foil layer similar to the foil layer 240 with respect to FIG. 2. In some embodiments, the layered structure 305 can comprise a resin layer similar to the resin layer 150 with respect to FIG. 1.

The layered structure 305 can be similar to the layered structure 105 of FIG. 1 and/or the layered structure 205 of FIG. 2. For example, the innermost layer of the layered structure 305 can comprise the first layer 310, followed by the intermediate foam layer 330 disposed on the first layer 310, and the second layer 320 disposed on the intermediate foam layer 230. In some embodiments, the foil layer 340 can be disposed on the second layer 320. In some embodiments, the resin layer 350 can be disposed on the foil layer 340. Thus, the outermost layer of the layered structure 305 can be the second layer 320 (in embodiments in which the foil layer 340 and the resin layer 350 are not implemented), the foil layer 340 (in embodiments in which the resin layer 350 is not implemented), or the resin layer 350.

In some embodiments, the layered structure 305 can be arranged in a forefoot region 301b, a toe region 301c and/or a midfoot region 301e of the shoe upper 201. In some embodiments, the layered structure 305 can comprise the foil layer 340 such that the forefoot region 301b, the toe region 301c, and/or the midfoot region 301e can be covered by the foil layer 340. In some embodiments, the layered structure 305 can comprise the resin layer 350 such that the forefoot region 301b, the toe region 301c, and/or the midfoot region 301e can be covered by the resin layer 350.

In some embodiments, the layered structure 205 can comprise one or more profile elements 370 to provide a pattern in the toe region 301c and/or the forefoot region 301b. In some embodiments, the one or more profile elements 370 can be created with a debossing process. As mentioned before, there can be several different types of profile elements 370, such as rubber protrusions and/or printed protrusions.

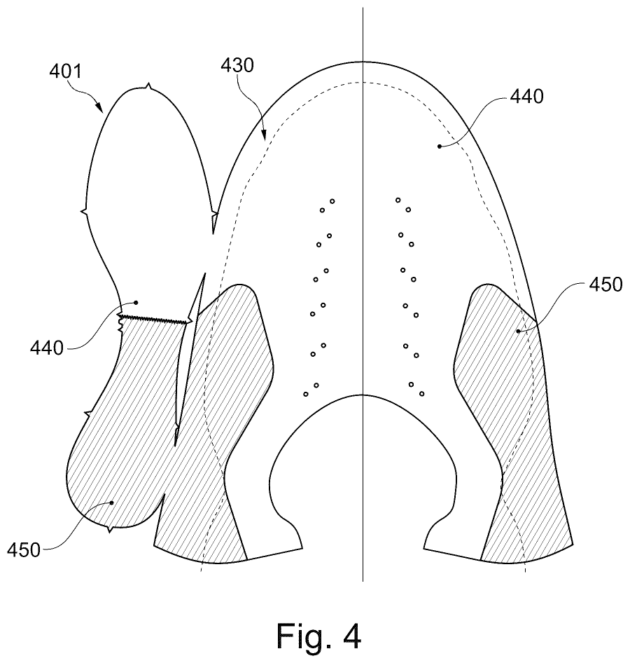

FIG. 4 shows a top view of a shoe upper 401 according to another embodiment of the present disclosure.

The shoe upper 401 is in a two-dimensional form before it is lasted to get its three-dimensional form.

In some embodiments, the shoe upper 401 can comprise a polyamide, PA, foam layer 430 extending from a top surface of the shoe upper 401 to a bottom surface of the shoe upper 401 to encircle a foot of the wearer. As mentioned, the PA foam layer extends along the sides and top of the foot of a wearer when it has its three-dimensional form.

In some embodiments, the PA foam layer 430 can comprise a thickness between 1.0 mm and 7.0 mm, a thickness between 2.5 mm and 6.0 mm, a thickness of approximately 4.5 mm or a thickness of approximately 6.0 mm.

In some embodiments, the PA foam layer 430 can comprise a first part 440 in the forefoot area and a second part 450 in the heel area of the shoe upper 400.

In some embodiments, the first part 440 can comprise a thickness between 1.0 mm and 5.0 mm, or approximately 4.5 mm.

In some embodiments, the second part 450 can comprise a thickness between 1.0 mm and 7 mm, or approximately 6.0 mm.

As mentioned, providing different thicknesses in different areas as described can provide advantages like flexibility in the forefoot area and cushioning in the heel are of the shoe upper 401.

in some embodiments, the first part 440 and the second part 450 can be at least partly connected by thermally or adhesively bonding. For example, the first part 440 and the second part 450 can be thermally or adhesively bonded in the heel area, resulting in an “edge-to-edge no stitch” bond in the heel area, which can avoid a stitched seam on the inside of the shoe upper 400. In their bottom parts (for example, an underfoot area), the first part 440 and the second part 450 can be connected by stitching, for example zig-zag stitching. Other stitching techniques are also conceivable.

In this way, a single (or continuous) piece for the shoe upper 401 can be provided from the PA foam layer 430.

In some embodiments, the shoe upper 401 can comprise a foil layer similar to the foil layer 240 with respect to FIG. 2, the foil layer 140 with respect to FIG. 1, etc. In some embodiments, the shoe upper 410 can comprise a resin layer similar to the resin layer 250 with respect to FIG. 2, the foil layer 150 with respect to FIG. 1, etc.

In some embodiments, a method for manufacturing such a shoe upper 401 can comprise the steps of wrapping the shoe upper 401 with the PA foam layer 430 and wrapping the first part 440 and the second part 450 around a shoe last and bonding the bottom portions of the two parts directly along a rim to the superior portions of the two parts. In some embodiments, the bonding can be performed by stitching.

A sole can then adhesively be bonded to the bottom portions of the two parts. Other bonding techniques for the sole to the shoe upper 401 are also conceivable.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but can be interchanged to meet various situations as would be appreciated by one of skill in the art.

The examples are illustrative, but not limiting, of the present disclosure. Other suitable modifications and adaptations of the variety of conditions and parameters normally encountered in the field, and which would be apparent to those skilled in the art, are within the spirit and scope of the present disclosure.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

What is claimed is:

1. A shoe upper comprising a layered structure comprising:
a. a first layer;
b. a second layer; and
c. an intermediate foam layer between the first layer and the second layer, wherein the intermediate foam layer comprises a polyamide (“PA”) foam material.

2. The shoe upper of claim 1, wherein the first layer is adapted to be turned inward of the shoe upper, the second layer is adapted to be turned outward of the shoe upper, the intermediate foam layer is adapted to provide stretchability and cushioning for ball contacts, or a combination thereof.

3. The shoe upper of claim 1, wherein the first layer forms an innermost surface of the shoe upper.

4. The shoe upper of claim 1, wherein the second layer forms an outermost surface of the shoe upper.

5. The shoe upper of claim 1, wherein the first layer is a first textile layer.

6. The shoe upper of claim 1, wherein the first layer comprises a coating, a film, a synthetic leather, or a leather.

7. The shoe upper of claim 5, wherein the second layer is a second textile layer.

8. The shoe upper of claim 1, wherein the second layer comprises a coating, a film, a synthetic leather, or a leather.

9. The shoe upper of claim 1, wherein one or more of the first layer or the second layer comprises a thickness between 0.05 mm and 1.0 mm.

10. The shoe upper of claim 1, wherein the intermediate foam layer comprises a thickness between 0.5 mm and 1.5 mm.

11. The shoe upper of claim 1, wherein the foam material of the intermediate foam layer is manufactured by a supercritical foaming process.

12. The shoe upper of claim 1, further comprising a foil layer on the second layer adapted to provide a coating for the shoe upper.

13. The shoe upper of claim 12, wherein the foil layer comprises a thickness between 0.01 mm and 0.1 mm.

14. The shoe upper of claim 1, further comprising a resin layer as an outermost layer having a PU material.

15. The shoe upper of claim 14, wherein the resin layer comprises a thickness between 0.01 mm and 0.1 mm.

16. The shoe upper of claim 1, wherein the layered structure further comprises a profile element.

17. The shoe upper of claim 1, further comprising multiple apertures in the intermediate foam layer.

18. The shoe upper of claim 1, wherein the first layer, the second layer and the intermediate foam layer form a single piece structure extending from a top surface of the shoe upper to a bottom surface of the shoe upper.

19. The shoe upper of claim 18, wherein the single piece structure completely encircles a foot of a wearer when in use.

20. The shoe upper of claim 18, wherein the single piece structure is arranged in a forefoot region of the shoe upper.

21. A sports shoe comprising a shoe upper of claim 1.

22. The sports shoe of claim 21, wherein the intermediate foam layer is arranged only in a throat region of the shoe upper.
